(19) United States
(12) Patent Application Publication
(10) Pub. No.: US 2006/0043808 A1
(43) Pub. Date: Mar. 2, 2006

(54) Hydrodynamic pressure bearing spindle motor

(75) Inventors: Dong Kil Son, Suwon (KR); Tae Hyeong Lim, Suwon (KR); Ta Kyoung Lee, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Samsung Electro-Mechanics Co., Ltd., Suwon (KR)

(21) Appl. No.: 10/993,368

(22) Filed: Nov. 22, 2004

(30) Foreign Application Priority Data
Sep. 1, 2004 (KR) 2004-69660

(51) Int. Cl. H02K 5/16; H02K 7/08; F16C 27/00

(52) U.S. Cl. 310/90; 384/112; 360/99.08

(57) ABSTRACT

A spindle motor, having a hydrodynamic pressure bearing, including: a stator including a core, on which at least one winding coil is wound, and a base provided with a central hole formed through the central area of the main body thereof so that the core is placed on the upper surface thereof; a rotor including a hub having a magnet formed on the outer circumference thereof to correspond to the winding coil leaving a designated interval with the winding coil, and a stop ring installed on the inner circumference of the hub; and a sleeve, for supporting the rotation of the rotor, including at least one dynamic pressure generating groove formed on the outer surface thereof correspondingly contacting the inner circumference of the hub and the stop ring, and a hub receiving hole formed through the central area of the main body thereof assembled with the central hole of the base.

### RELATED APPLICATIONS

The present application is based on, and claims priority from, Korean Application Number 2004-69660, filed Sep. 1, 2004, the disclosure of which is hereby incorporated by reference herein in the entirety.

### BACKGROUND OF THE INVENTION

1. Field of the Invention

The present invention relates to a spindle motor having a hydrodynamic pressure bearing, and more particularly to a hydrodynamic pressure bearing spindle motor, which maximizes the dimensions of dynamic pressure generating portions formed on slide planes between a stationary member and a rotary member, thereby improving axial rigidity, reducing axial loss to achieve low power consumption, being rotated at a high degree of precision, reducing the number of required components to be decreased in terms of size, and reducing production costs.

2. Description of the Related Art

Generally, there is friction between a motor, employing a ball bearing, and a shaft, thereby generating noise and vibration. Such vibration is refereed to as NRRO (Non Repeatable Run Out), and serves as an obstacle in increasing the density of tracks of a hard disk.

On the other hand, a spindle motor having a hydrodynamic pressure bearing, which maintains its axial rigidity by means of only the dynamic pressure of lubricating oil, is based on the centrifugal force, thus does not generate metallic friction, and has an increased stability when the spindle motor is rotated at a high speed, thereby reducing the generation of noise and vibration. Further, the above spindle motor drives a rotary structure more stably than the motor having the ball bearing, thereby being mainly applied to a high-end optical disk unit or a magnetic disk unit.

The hydrodynamic pressure bearing, employed by the above-described spindle motor, comprises a shaft serving as a rotary center, and a metal sleeve assembled with the shaft for forming slide planes. Herringbone-shaped or spiral-shaped dynamic pressure generating grooves are formed in the slide planes along one of the shaft and the metal sleeve, and a fine gap formed between the slide planes of the shaft and the sleeve is filled with lubricating oil. Both members do not contact due to the dynamic pressure generated from the dynamic pressure generating grooves formed in the slide planes, thereby allowing the hydrodynamic pressure bearing to have a reduced load for friction and to support a rotor serving as a rotary member when the rotation is performed.

In case that the above hydrodynamic pressure bearing is applied to the spindle motor, it is possible to support the rotor of the motor using the fluid, i.e., the lubricating oil, thereby reducing noise generated from the motor and power consumption of the motor, and improving impact resistance of the motor.

FIG. 1 is a longitudinal-sectional view of a conventional hydrodynamic pressure bearing spindle motor. As shown in FIG. 1, the conventional hydrodynamic pressure bearing spindle motor 1 comprises a stator 10, and a rotor 20. The stator 10 includes a base 12, in which a cylindrical sleeve 32 made of metal is disposed in the central area thereof, and at least one winding coil 14 placed on the upper surface of the base 12.

The rotor 20, which is rotated against the stator 10, includes a cup-shaped hub 24. The hub 24 includes a boss unit 21, with which the upper end of a shaft 34 is assembled, and a skirt unit 22, on which a magnet 23 corresponding to the winding coil 14 is installed.

The sleeve 32 has large and small inner diameter portions 32a and 32b, which are fixedly inserted into a central hole of the base 12 and are assembled with the shaft 34, and the shaft 34 has large and small outer diameter portions 34a and 34b, which are inserted into the large and small inner diameter portions 32a and 32b of the sleeve 32.

When the shaft 34 is assembled with the sleeve 32, a pressing ring 35, the external end of which is fixed to the upper end of the sleeve 32, is installed so as to support downwardly the shaft 34 assembled with the sleeve 32, slide planes leaving at a small clearance is formed between the inner diameter of the sleeve 32 and the outer diameter of the shaft 34 along dynamic pressure generating grooves G formed in the shaft 34.

When fluid, i.e., lubricating oil, is poured onto the slide planes between the inner diameter of the sleeve 32 and the outer diameter of the shaft 34, an upper thrust dynamic pressure portion for generating dynamic pressure due to the relative rotation is formed between the lower surface of the pressing ring 35 and the upper surface of the large outer diameter portion 34a, and a lower thrust dynamic pressure portion for generating dynamic pressure due to the relative rotation is formed between the lower surface of the large outer diameter portion 34a and the bottom surface of the larger inner diameter portion 32a of the sleeve 32.

Further, radial dynamic pressure portions for generating dynamic pressure to the relative rotation are respectively formed between the inner circumferential surfaces of the large and small inner diameter portions 32a and 32b of the sleeve 32 and the outer circumferential surfaces of the large and small outer diameter portions 34a and 34b of the shaft.34.

Since the conventional spindle motor 1 comprises the pressing ring 35 having a designated height formed on the upper end of the sleeve 32, regions for the radial dynamic pressure portions are not extended to the uppermost end of the sleeve 32, and have a reduced height in proportion to the height h of the pressing ring 35, thereby causing dynamic pressure loss of the radial dynamic pressure portions in proportion to the reduced height.

Since the upper and lower thrust dynamic pressure portions are formed on the inner diameter portion of the sleeve 32, regions for the upper and lower thrust dynamic pressure portions are not extended to the maximal outer diameter of the sleeve 32, and are reduced in proportion to the difference t of thicknesses between the inner diameter and the outer diameter of the sleeve 32, thereby causing dynamic pressure loss of the upper and lower thrust dynamic pressure portions in proportion to the reduction.

The large and small outer diameter portions 34a and 34b of the shaft 34, assembled with the sleeve 32, must be finely processed so as to correspond to the large and small inner diameter portions 32a and 32b of the sleeve 32, thereby increasing costs taken to mechanically process the inner diameter portions of the sleeve 32 and the outer diameter portions of the shaft 34, thus increasing production costs of the motor 1.

A dynamic pressure non-generating portion is formed between the closed bottom surface of the sleeve 32 and the lower surface of the shaft 34. When the spindle motor 1 is driven, frictional resistance at the dynamic pressure non-generating portion is increased, thereby causing axial loss.

As time goes by, the lubricating oil, which is poured onto the slide planes between the sleeve 32 and the shaft 34, is increasingly collected into the dynamic pressure non-generating portion, thereby increasing negative influences due to the thermal expansion of the oil.

That is, the lubricating oil having a designated viscosity, which is placed between the sleeve 32, serving as a stationary member, and the shaft 34, serving as a rotary member, generates friction therebetween, i.e., axial loss, and has a high temperature, thus being thermally expanded and having a large volume. Thereby, the lubricating oil is leaked to the outside through a gap between the sleeve 32 and the shaft 34.

When the temperature of the lubricating oil is lowered, the lubricating oil has a decreased volume and reaches its original state so as to maintain the quantity of the oil. However, the total quantity of the lubricating oil is decreased due to the leakage of the oil, thereby generating noise and vibration, and reducing the lifespan of the spindle motor 1.

### SUMMARY OF THE INVENTION

Therefore, the present invention has been made in view of the above problems, and it is an object of the present invention to provide a hydrodynamic pressure bearing spindle motor, in which dimensions of portions, of slide planes between a stationary member and a rotary member, for generating dynamic pressure are maximized, thereby improving axial bearing capacity and reducing axial loss, thus minimizing power consumption.

It is another object of the present invention to provide a hydrodynamic pressure bearing spindle motor having a reduced number of required components, thereby having a small size and reducing production costs.

In accordance with one aspect of the present invention, the above and other objects can be accomplished by the provision of a hydrodynamic pressure bearing spindle motor comprising: a stator including a core, on which at least one winding coil is wound, and a base provided with a central hole formed through the central area of the main body thereof so that the core is placed on the upper surface thereof; a rotor including a hub having a magnet formed on the outer circumference thereof to correspond to the winding coil leaving a designated interval with the winding coil, and a stop ring integrally installed on the inner circumference of the hub; and a sleeve, for supporting the rotation of the rotor against the stator, including at least one dynamic pressure generating groove formed on the outer surface thereof correspondingly contacting the inner circumference of the hub and the stop ring, and a hub receiving hole formed through the central area of the main body thereof assembled with the central hole of the base.

Preferably, the hub may include an axial boss unit protruded downwardly from the main body of the hub and inserted into the hub receiving hole; and a skirt unit having a hollow cylindrical structure provided with the outer circumference, on which the magnet is placed, and the inner circumference, on which the stop ring is placed.

More preferably, the axial boss unit may have a constant cylindrical structure having a constant outer diameter so that the outer surface of the axial boss unit contacts the inner surface of the hub receiving hole.

More preferably, the axial boss unit may have an inclined cylindrical structure having an outer diameter gradually decreased from the upper end to the lower end so that the outer surface of the axial boss unit is separated from the inner surface of the hub receiving hole.

More preferably, there may be a gap having a designated size between the lower surface of the axial boss unit and the bottom surface of the hub receiving hole.

Preferably, the sleeve may include a large outer diameter portion, through which the hub receiving hole is formed, and a small outer diameter portion, which is assembled with the central hole of the base; at least one upper dynamic pressure generating groove for generating upper thrust dynamic pressure may be formed in the upper surface of the large outer diameter portion corresponding to the upper inner surface of the hub; at least one outer circumferential dynamic pressure generating groove for generating outer circumferential radial dynamic pressure may be formed in the outer circumferential surface of the large outer diameter portion corresponding to the inner circumferential surface of the hub; and at least one lower dynamic pressure generating groove for generating lower thrust dynamic pressure may be formed in the lower surface of the large outer diameter portion corresponding to the upper surface of the stop ring.

Preferably, the sleeve may include a large outer diameter portion, through which the hub receiving hole is formed, and a small outer diameter portion, which is assembled with the central hole of the base; at least one upper dynamic pressure generating groove for generating upper thrust dynamic pressure may be formed in the upper surface of the large outer diameter portion corresponding to the upper inner surface of the hub; at least one inner circumferential dynamic pressure generating groove for generating inner circumferential radial dynamic pressure may be formed in the inner circumferential surface of the hub receiving hole; and at least one lower dynamic pressure generating groove for generating lower thrust dynamic pressure may be formed in the lower surface of the large outer diameter portion corresponding to the upper surface of the stop ring.

Preferably, the sleeve may include a large outer diameter portion, through which the hub receiving hole is formed, and a small outer diameter portion, which is assembled with the central hole of the base; at least one upper dynamic pressure generating groove for generating upper thrust dynamic pressure may be formed in the upper surface of the large outer diameter portion corresponding to the upper inner surface of the hub; at least one outer circumferential dynamic pressure generating groove for generating outer circumferential radial dynamic pressure may be formed in the outer circumferential surface of the large outer diameter portion corresponding to the inner circumferential surface of the hub; at least one inner circumferential dynamic pressure generating groove for generating inner circumferential radial dynamic pressure may be formed in the inner circumferential surface of the hub receiving hole; and at least one lower dynamic pressure generating groove for generating lower thrust dynamic pressure may be formed in the lower surface of the large outer diameter portion corresponding to the upper surface of the stop ring.

Preferably, at least one vent hole may be formed through the outer surface of the sleeve so that the vent hole communicates with the hub receiving hole.

Preferably, the sleeve may further include selectively or simultaneously an upper sealing and oil-storing unit and a lower sealing and oil-storing unit, which prevent lubricating oil, supplied to the dynamic pressure generating grooves, from flowing out, and store the lubricating oil.

More preferably, the upper sealing and oil-storing unit may be formed between the horizontal upper inner surface of the hub and an inclined portion sloping downwardly to the inner diameter to be gradually distant from the upper surface of the sleeve.

More preferably, the lower sealing and oil-storing unit may be formed between the vertical outer surface of the sleeve and an inclined portion being gradually distant from the inner circumferential surface of the stop ring from the upper end to the lower end.

More preferably, the inclined portion may have a V-shaped or arc-shaped cross-section.

More preferably, the lower sealing and oil-storing unit may be formed between a protrusion slantingly protruded upwardly from the upper end of the inner circumferential surface of the stop ring, and a reception groove formed in the outer surface of the sleeve corresponding to the stop ring for receiving the protrusion.

More preferably, an inclined plane of the protrusion may have a gradient, against the horizontal bottom surface, lower than that of an inclined plane of the reception groove so that the inclined planes facing each other do not contact.

In accordance with another aspect of the present invention, there is provided a hydrodynamic pressure bearing spindle motor comprising: a stator including a core, on which at least one winding coil is wound, and a base provided with a central hole formed through the central area of the main body thereof so that the core is placed on the upper surface thereof; a rotor including a hub having a magnet formed on the outer circumference thereof to correspond to the winding coil leaving a designated interval with the winding coil, and a stop ring integrally installed on the inner circumference of the hub; a sleeve, for supporting the rotation of the rotor against the stator, including at least one dynamic pressure generating groove formed on the outer surface thereof correspondingly contacting the inner circumference of the hub and the stop ring, and a hub receiving hole formed through the central area of the main body thereof for receiving the hub; and a fixing cap assembled with the central hole of the base for fixedly supporting a lower end of the sleeve.

Preferably, the hub may include an axial boss unit protruded downwardly from the main body of the hub and inserted into the hub receiving hole; and a skirt unit having a hollow cylindrical structure provided with the outer circumference, on which the magnet is placed, and the inner circumference, on which the stop ring is placed.

More preferably, the axial boss unit may have a constant cylindrical structure having a constant outer diameter so that the outer surface of the axial boss unit contacts the inner surface of the hub receiving hole.

More preferably, the axial boss unit may have an inclined cylindrical structure having an outer diameter gradually decreased from the upper end to the lower end so that the outer surface of the axial boss unit is separated from the inner surface of the hub receiving hole.

More preferably, as embodied by claim 17, there may be a gap having a designated size between the lower surface of the axial boss unit and the bottom surface of the hub receiving hole.

Preferably, the sleeve may include a large outer diameter portion, through which the hub receiving hole is formed, and a small outer diameter portion, which is assembled with the central hole of the base; at least one upper dynamic pressure generating groove for generating upper thrust dynamic pressure may be formed in the upper surface of the large outer diameter portion corresponding to the upper inner surface of the hub; at least one outer circumferential dynamic pressure generating groove for generating outer circumferential radial dynamic pressure may be formed in the outer circumferential surface of the large outer diameter portion corresponding to the inner circumferential surface of the hub; and at least one lower dynamic pressure generating groove for generating lower thrust dynamic pressure may be formed in the lower surface of the large outer diameter portion corresponding to the upper surface of the stop ring.

Preferably, the sleeve may include a large outer diameter portion, through which the hub receiving hole is formed, and a small outer diameter portion, which is assembled with the central hole of the base; at least one upper dynamic pressure generating groove for generating upper thrust dynamic pressure may be formed in the upper surface of the large outer diameter portion corresponding to the upper inner surface of the hub; at least one inner circumferential dynamic pressure generating groove for generating inner circumferential radial dynamic pressure may be formed in the inner circumferential surface of the hub receiving hole; and at least one lower dynamic pressure generating groove for generating lower thrust dynamic pressure may be formed in the lower surface of the large outer diameter portion corresponding to the upper surface of the stop ring.

Preferably, the sleeve may include a large outer diameter portion, through which the hub receiving hole is formed, and a small outer diameter portion, which is assembled with the central hole of the base; at least one upper dynamic pressure generating groove for generating upper thrust dynamic pressure may be formed in the upper surface of the large outer diameter portion corresponding to the upper inner surface of the hub; at least one outer circumferential dynamic pressure generating groove for generating outer circumferential radial dynamic pressure may be formed in the outer circumferential surface of the large outer diameter portion corresponding to the inner circumferential surface of the hub; at least one inner circumferential dynamic pressure generating groove for generating inner circumferential radial dynamic pressure may be formed in the inner circumferential surface of the hub receiving hole; and at least one lower dynamic pressure generating groove for generating lower thrust dynamic pressure may be formed in the lower surface of the large outer diameter portion corresponding to the upper surface of the stop ring.

Preferably, at least one vent hole may be formed through the outer surface of the sleeve so that the vent hole communicates with the hub receiving hole.

Preferably, a disk-shaped fixing groove, into which inner and outer surfaces of the lower end of the sleeve provided with the hub receiving hole are fixedly inserted, may be formed in the upper surface of the fixing cap.

More preferably, the inner and outer surfaces of the lower end of the sleeve may be connected to the fixing groove by a bonding agent.

More preferably, at least one disk-shaped inner groove and at least one disk-shaped outer groove may be respectively formed in the inner and outer surfaces of the lower end of the sleeve.

More preferably, the inner and outer surfaces of the lower end of the sleeve may be connected to the fixing groove by thermocompression bonding.

Preferably, a circular-shaped fixing groove, into which an outer surface of the lower end of the sleeve provided with the hub receiving hole is fixedly inserted, may be formed in the upper surface of the fixing cap.

More preferably, the inner and outer surfaces of the lower end of the sleeve may be connected to the fixing groove by a bonding agent.

Preferably, at least one disk-shaped outer groove may be formed in the outer surface of the lower end of the sleeve.

Preferably, the sleeve may further include selectively or simultaneously an upper sealing and oil-storing unit and a lower sealing and oil-storing unit, which prevent lubricating oil, supplied to the dynamic pressure generating grooves, from flowing out, and store the lubricating oil.

More preferably, the upper sealing and oil-storing unit may be formed between the horizontal upper inner surface of the hub and an inclined portion sloping downwardly to the inner diameter to be gradually distant from the upper surface of the sleeve.

More preferably, the lower sealing and oil-storing unit may be formed between the vertical outer surface of the sleeve and an inclined portion being gradually distant from the inner circumferential surface of the stop ring from the upper end to the lower end.

More preferably, the inclined portion may have a V-shaped or arc-shaped cross-section.

More preferably, the lower sealing and oil-storing unit may be formed between a protrusion slantingly protruded upwardly from the upper end of the inner circumferential surface of the stop ring, and a reception groove formed in the outer surface of the sleeve corresponding to the stop ring for receiving the protrusion.

More preferably, an inclined plane of the protrusion may have a gradient, against the horizontal bottom surface, lower than that of an inclined plane of the reception groove so that the inclined planes facing each other do not contact.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a longitudinal-sectional view of a conventional hydrodynamic pressure bearing spindle motor;

FIG. 2 is a schematic view of a hydrodynamic pressure bearing spindle motor in accordance with a first embodiment of the present invention;

FIG. 3 is an exploded view of the hydrodynamic pressure bearing spindle motor in accordance with the first embodiment of the present invention;

FIG. 4 is a schematic view of a modification of the hydrodynamic pressure bearing spindle motor in accordance with the first embodiment of the present invention;

FIG. 5a is a detailed view of an upper sealing and oil-storing unit employed by the hydrodynamic pressure bearing spindle motor in accordance with the first embodiment of the present invention;

FIGS. 5b and 5c are detailed views of lower sealing and oil-storing units employed by the hydrodynamic pressure bearing spindle motor in accordance with the first embodiment of the present invention;

FIG. 6 is a schematic view of a hydrodynamic pressure bearing spindle motor in accordance with a second embodiment of the present invention;

FIG. 7 is an exploded view of the hydrodynamic pressure bearing spindle motor in accordance with the second embodiment of the present invention;

FIG. 8 is a schematic view of a modification of the hydrodynamic pressure bearing spindle motor in accordance with the second embodiment of the present invention;

FIG. 9a is a detailed view of an upper sealing and oil-storing unit employed by the hydrodynamic pressure bearing spindle motor in accordance with the second embodiment of the present invention;

FIGS. 9b and 9c are detailed views of lower sealing and oil-storing units employed by the hydrodynamic pressure bearing spindle motor in accordance with the second embodiment of the present invention; and

FIGS. 10a and 10b are schematic views of modifications of the hydrodynamic pressure bearing spindle motor in accordance with the second embodiment of the present invention.

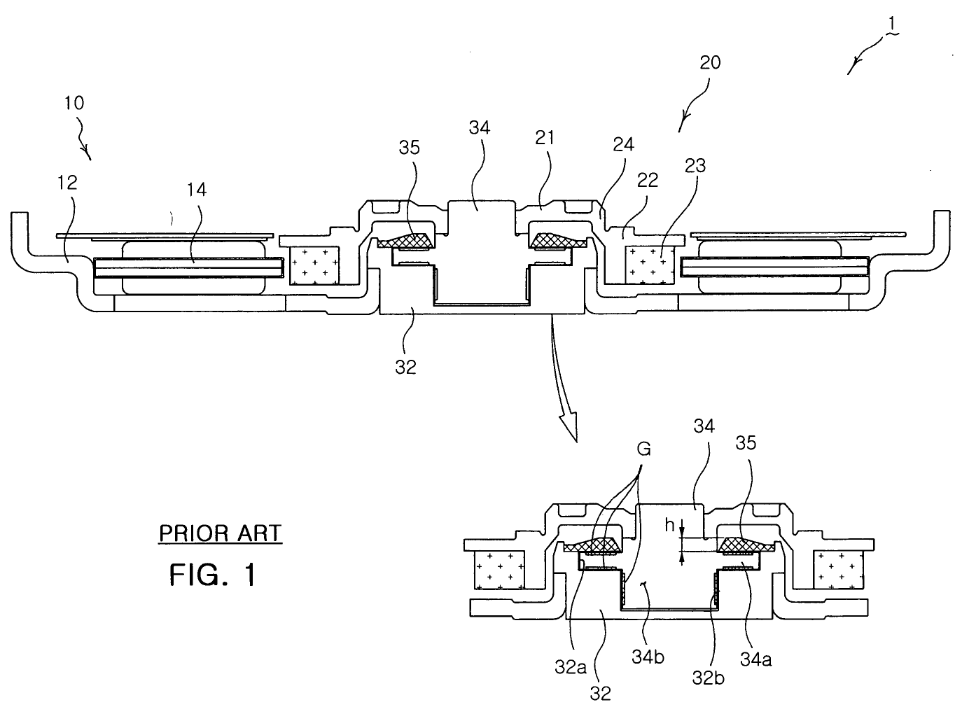

### DESCRIPTION OF THE PREFERRED EMBODIMENTS

Now, preferred embodiments of the present invention will be described in detail with reference to the annexed drawings.

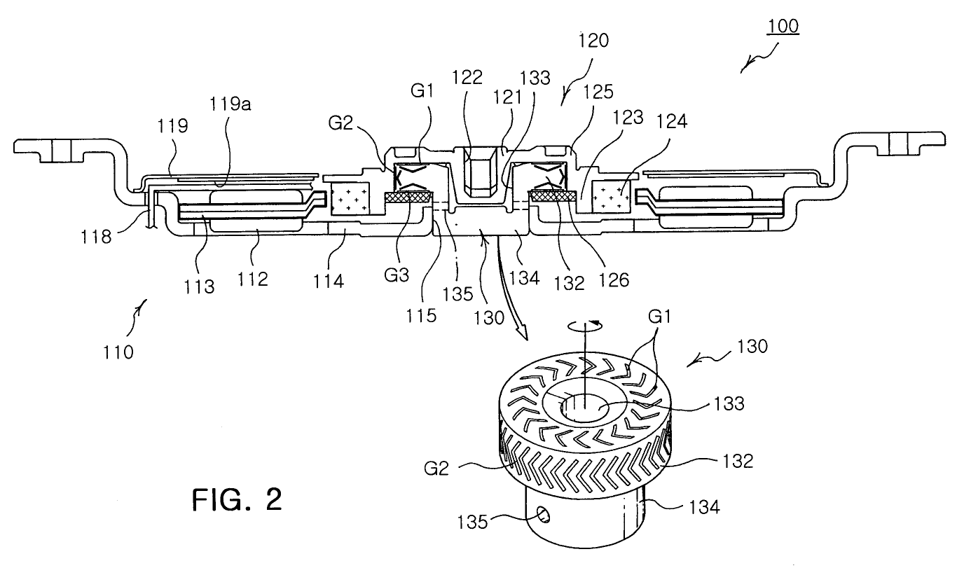

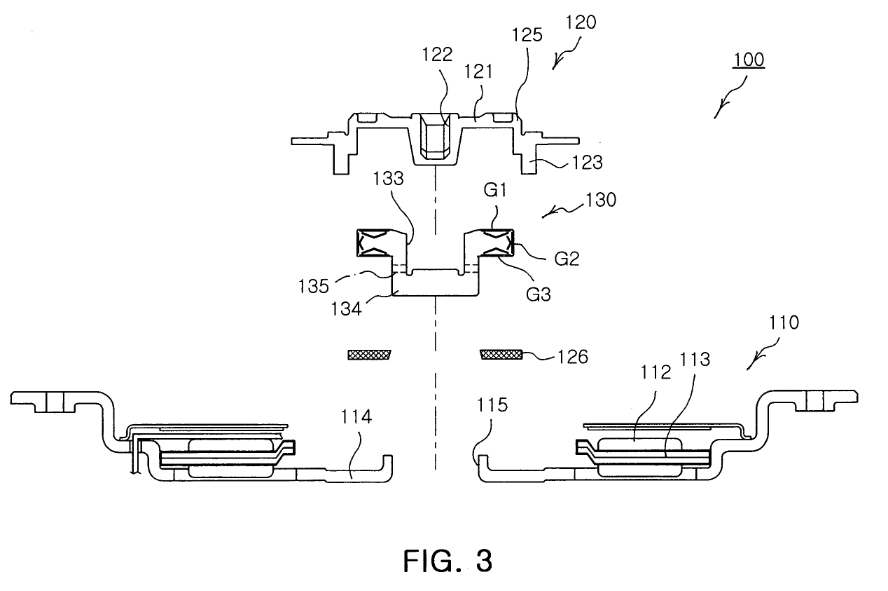

FIG. 2 is a schematic view of a hydrodynamic pressure bearing spindle motor in accordance with a first embodiment of the present invention, and FIG. 3 is an exploded view of the hydrodynamic pressure bearing spindle motor in accordance with the first embodiment of the present invention. As shown in FIGS. 2 and 3, the hydrodynamic pressure bearing spindle motor 100 serves to increase dimensions of dynamic pressure generating portions formed on a support member for supporting a rotary member so that the rotary member is rotated against a stationary member, thereby increasing axial bearing force. The hydrodynamic pressure bearing spindle motor 100 comprises a stator 110, a rotor 120, and a sleeve 130.

That is, the stator 110 is a stationary structure including a winding coil 112 for forming an electric field having a designated intensity when power is applied to the stator 110, a core 113 formed by extending at least one pole, on which at least one winding coil 112 is wound, in a radial direction, and a base 114 provided with a central hole 115 having a designated size formed through the central area of a main body thereof so that the core 113 is fixed to the upper surface thereof.

The upper surface of the stator 110 is covered with a cover member 119 provided with an insulating material 119a integrally attached to the lower surface thereof, and the winding coil 112 is electrically connected to a flexible substrate 118.

The rotor 120 is a rotary structure, which is rotated against the stator 110, including a hub 125 in a cup shape having a disk-shaped magnet 124 formed on the outer circumference thereof corresponding to the winding coil 112, and a stop ring 126 installed on the inner circumference of the hub 125 for interfering with the sleeve 130 to prevent the hub 125 from being separated from the rotor 120.

The hub 125 includes a fixing hole 122 having a designated depth formed through the central area of the body thereof for fixing a rotary object using a screw member (not shown).

The hub 125, serving as a rotary structure, includes an axial boss unit 121, and a skirt unit 123. The axial boss unit 121 is a protrusion, which is obtained by downwardly protruding from the main body of the hub 125, and is inserted into a hub receiving hole 133 of the sleeve 130. The skirt unit 123 is a hollow cylindrical stationary member provided with the outer circumference, on which the magnet 124 for forming a magnetic field having a designated intensity is installed corresponding to the winding coil 112, and the inner circumference, to which the outer circumference of the stop ring 126 is fixed.

Here, the skirt unit 123 is installed such that the lower end and the outer circumference end thereof extended in a directly downward direction and a radial direction do not interfere with the bottom surface of the base 114 or the core 113.

A space, for disposing the sleeve 130 fixed to the base 114 to generate thrust dynamic pressure and radial dynamic pressure, is formed by the axial boss unit 121, the skirt unit 123, and the stop ring 126.

The axial boss unit 121, which is disposed in the hub receiving hole 133 of the sleeve 130, has a constant cylindrical structure, the outer surface of which is parallel with the inner surface of the hub receiving hole 133, so that the outer surface of the axial boss unit 121 contacts the inner surface of the hub receiving hole 133, or has an inclined cylindrical structure, the outer diameter of which is decreased from the upper end to the lower end such that the distance between the outer surface of the axial boss unit 121 and the inner surface of the hub receiving hole 133 is gradually increased from the upper end to the lower end, so that the outer surface of the axial boss unit 121 is separated from the inner surface of the hub receiving hole 133.

Preferably, there is a gap having a designated distance between the lower surface of the axial boss unit 121 and the bottom surface of the hub receiving hole 133 so that the lower surface of the axial boss unit 121 does not contact the bottom surface of the hub receiving hole 133, thereby not causing axial loss.

The sleeve 130, which supports the rotation the rotor 120, serving as the rotary structure, against the stator 110, serving as the stationary structure, includes dynamic pressure generating grooves G1, G2, and G4 formed in the outer surface thereof corresponding to the inner surface of the hub 125, and a dynamic pressure generating grove G3 formed in the outer surface thereof corresponding to the stop ring 126 formed integrally with the hub 125 and rotated together with the rotation of the hub 125.

The hub receiving hole 133 is formed through the central portion of the main body of the sleeve 130, which is inserted into the central hole 115 of the base 114.

The sleeve 130 includes a large outer diameter portion 132 provided with the hub receiving hole 133 formed therethrough, and a small outer diameter portion 134 inserted into the central hole 115.

In case that the axial boss unit 121 has the inclined cylindrical structure, the outer diameter of which is decreased from the upper end to the lower end, as shown in FIG. 2, at least one upper dynamic pressure generating groove G1 for generating upper thrust dynamic pressure is formed in a circumferential direction in the upper surface of the large outer diameter portion 132 contacting the upper inner surface of the skirt unit 123 of the hub 125, at least one outer circumferential dynamic pressure generating groove G2 for generating outer circumferential radial dynamic pressure is formed in a circumferential direction in the outer circumferential surface of the large outer diameter portion 132 contacting the inner circumferential surface of the skirt unit 123 of the hub 125, and at least one lower dynamic pressure generating groove G3 for generating lower thrust dynamic pressure is formed in a circumferential direction in the lower surface of the large outer diameter portion 132 contacting the upper surface of the stop ring 126 rotated together with the rotation of the hub 125.

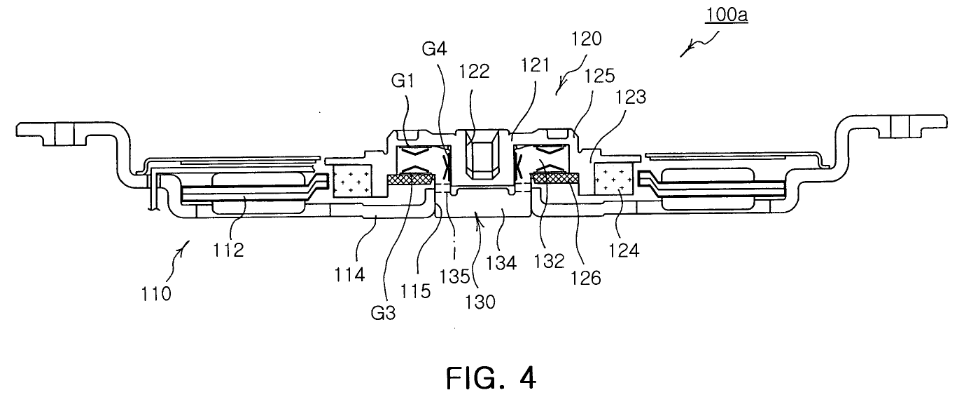

Further, in case that the axial boss unit 121 of the hub 125 constituting the rotor 120 of a spindle motor 100a has the constant cylindrical structure, the outer diameter of which is constantly maintained from the upper end to the lower end as shown in FIG. 4, at least one upper dynamic pressure generating groove G1 for generating upper thrust dynamic pressure is formed in a circumferential direction in the upper surface of the large outer diameter portion 132 contacting the upper inner surface of the skirt unit 123 of the hub 125, at least one inner circumferential dynamic pressure generating groove G4 for generating inner circumferential radial dynamic pressure is formed in a circumferential direction in the inner circumferential surface of the hub receiving hole 133 contacting the outer circumferential surface of the axial boss unit 121, and at least one lower dynamic pressure generating groove G3 for generating lower thrust dynamic pressure is formed in a circumferential direction in the lower surface of the large outer diameter portion 132 contacting the upper surface of the stop ring 126.

Here, together with the inner circumferential dynamic pressure generating groove G4, which is formed in the large outer diameter portion 132 of the sleeve 130, at least one outer circumferential dynamic pressure generating groove G2 for generating outer circumferential radial dynamic pressure may be formed in a circumferential direction in the outer circumferential surface of the large outer diameter portion 132 contacting the inner circumferential surface of the skirt unit 123.

In this case, radial dynamic pressures generated from the inner and outer circumferential surfaces of the sleeve 130 are determined by the height of the sleeve 130 regardless of the height of the stop ring 126, and thrust dynamic pressures generated from the upper and lower surfaces of the sleeve 130 are maximally generated from the outer diameter of the sleeve 130. Thereby, it is possible to maximally expand the dimensions of portions for generating dynamic pressure.

As shown in FIGS. 2 to 4, at least one vent hole 135, for connecting a space, formed between the hub receiving hole 133 of the sleeve 125 and the axial boss unit 121 of the hub 125, to the outside so that the space kept at atmospheric pressure, is formed through the outer surface of the sleeve 130.

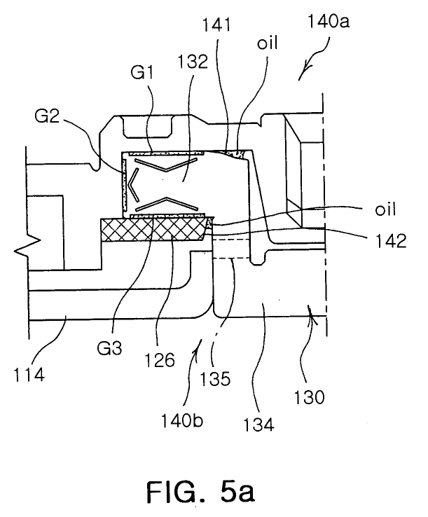

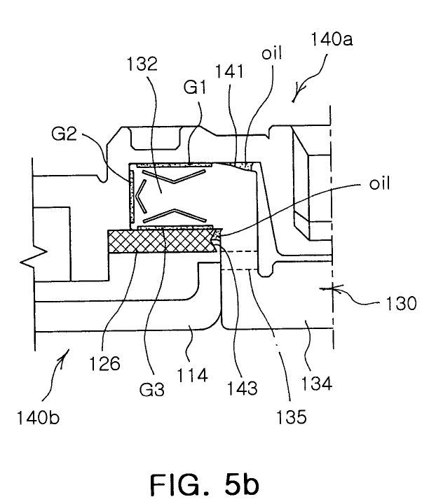

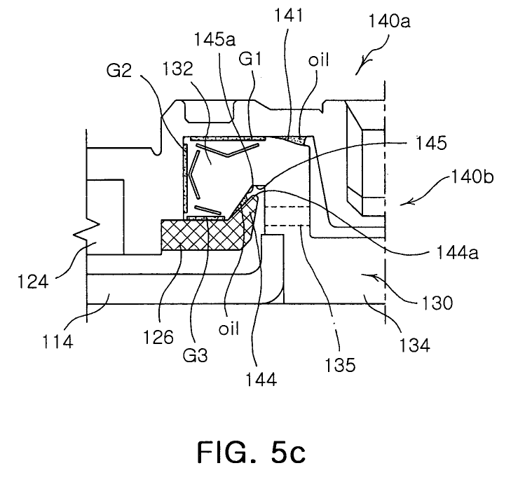

FIGS. 5a, 5b, and 5c illustrate upper and lower sealing and oil-storing units of the hydrodynamic pressure bearing spindle motor in accordance with the first embodiment of the present invention. The upper sealing and oil-storing unit 140a and the lower sealing and oil-storing unit 140b, which prevent lubricating oil, supplied to the dynamic pressure generating grooves G1, G2, and G3 formed in slide planes of the sleeve 130 for generating dynamic pressure due to the relative rotation of the rotary structure against the stationary structure, from flowing out, and store the lubricating oil, are selectively or simultaneously formed on the sleeve 130.

The upper sealing and oil-storing unit 140a is formed between the horizontal upper inner surface of the hub 125 and an inclined portion 141 sloping downwardly to the inner diameter to be gradually distant from the upper surface of the sleeve 130 so that the upper sealing and oil-storing unit 140a prevents the lubricating oil, supplied to the upper dynamic pressure generating groove G1, from flowing out, and stores the lubricating oil.

Here, preferably, the inclined portion 141 has a gradient of 30 degrees or less so that the inclined portion 141 is gradually distant from the horizontal upper inner surface of the hub 125 to store the lubricating oil flowing out of the upper dynamic pressure generating groove G1 by means of a capillary action.

Further, the lower sealing and oil-storing unit 140b is formed between the vertical outer surface of the sleeve 130 and a linear inclined portion 142 being gradually distant from the inner circumferential surface of the stop ring 126 from the upper end to the lower end so that the lower sealing and oil-storing unit 140b prevents the lubricating oil, supplied to the outer circumferential dynamic pressure generating groove G2 and the lower dynamic pressure generating groove G3 for generating outer circumferential radial dynamic pressure and lower thrust dynamic pressure, from flowing out, and stores the lubricating oil by means of the capillary action.

Here, the lower sealing and oil-storing unit 140b may be formed by the linear inclined portion 142 as shown in FIG. 5a, or may be formed by an inclined portion 143 having a V-shaped cross-section as shown in FIG. 5b so as to form a space for storing the lubricating oil between the inclined portion 143 and the vertical outer surface of the sleeve 130. The inclined portion 143 may have an arc-shaped cross-section.

The lower sealing and oil-storing unit 140b includes a protrusion 144 slantingly protruded upwardly from the upper end of the inner circumferential surface of the stop ring 126, and a reception groove 145 formed in the outer surface of the sleeve 130 corresponding to the stop ring 126 for receiving the protrusion 144. An inclined plane 144a of the protrusion 144 has a gradient, against the horizontal bottom surface, lower than that of an inclined plane 145a of the reception groove 145 so that the inclined planes 144a and 145a facing each other do not contact. The inclined plane 144a of the protrusion 144 prevents the lubricating oil, supplied to the outer circumferential dynamic pressure generating groove G2 and the lower dynamic pressure generating groove G3 for generating outer circumferential radial dynamic pressure and lower thrust dynamic pressure, from flowing out, and stores the lubricating oil in the lower sealing and oil-storing unit 140b formed between the inclined planes 144a and 145a by means of the capillary action.

Here, preferably, the inclined plane 144a of the protrusion 144 has a gradient of 45 degrees or less against the horizontal bottom surface, and the inclined plane 145a of the reception groove 145 has a gradient of 45 degrees or more against the horizontal bottom surface.

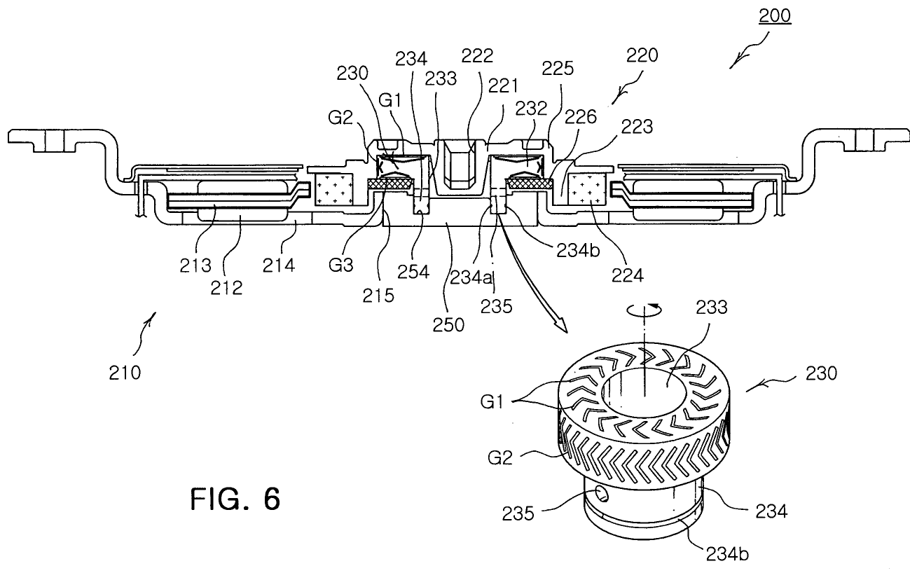

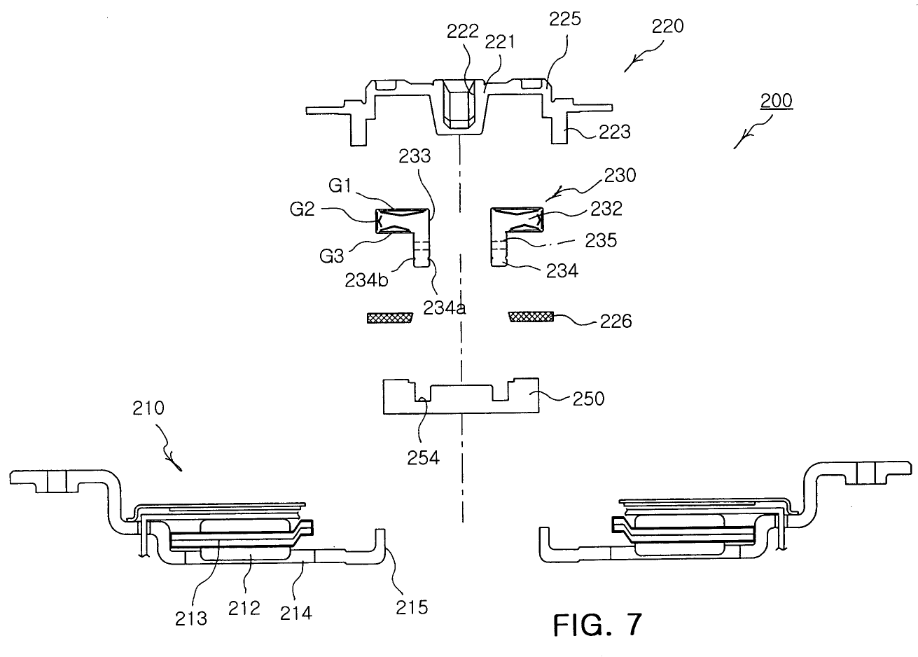

FIG. 6 is a schematic view of a hydrodynamic pressure bearing spindle motor in accordance with a second embodiment of the present invention, and FIG. 7 is an exploded view of the hydrodynamic pressure bearing spindle motor in accordance with the second embodiment of the present invention. As shown in FIGS. 6 and 7, the hydrodynamic pressure bearing spindle motor 200 serves to increase dimensions of dynamic pressure generating portions formed on a support member for supporting a rotary member so that the rotary member is rotated against a stationary member, thereby increasing axial bearing force. The hydrodynamic pressure bearing spindle motor 200 comprises a stator 210, a rotor 220, a sleeve 130, and a fixing cap 250.

That is, the stator 210 is a stationary structure including at least one winding coil 212 for forming an electric field having a designated intensity when power is applied to the stator 210, a core 213 formed by extending a pole, on which the winding coil 212 is wound in a designated number, in a radial direction, and a base 214 provided with a central hole 215 having a designated size formed through the central area of a main body thereof so that the core 213 is fixed to the upper surface thereof.

The rotor 220 is a rotary structure, which is rotated against the stator 210, including a hub 225 in a cup shape having a disk-shaped magnet 224 formed on the outer circumference thereof corresponding to the winding coil 212.

The hub 225 is a rotary structure, provided with a fixing hole 222 having a designated depth formed through the central area of the body thereof for fixing a rotary object using a fixing screw, including an axial boss unit 221, and a skirt unit 223. The axial boss unit 221 is a downward protrusion, which is inserted into a hub receiving hole 233 of the sleeve 230. The skirt unit 223 having a hollow cylindrical structure is provided with the outer circumference, on which the magnet 224 is installed corresponding to the winding coil 212, and the inner circumference, to which the stop ring 226 is integrally fixed.

The axial boss unit 221, which is disposed in the hub receiving hole 233 of the sleeve 230, has a constant cylindrical structure, the outer surface of which is parallel with the inner surface of the hub receiving hole 233, so that the outer surface of the axial boss unit 221 contacts the inner surface of the hub receiving hole 233, or has an inclined cylindrical structure, the outer diameter of which is decreased from the upper end to the lower end such that the distance between the outer surface of the axial boss unit 221 and the inner surface of the hub receiving hole 233 is gradually increased from the upper end to the lower end, so that the outer surface of the axial boss unit 221 is separated from the inner surface of the hub receiving hole 233.

The sleeve 230, which supports the rotation of the rotor 220, serving as the rotary structure, against the stator 210, serving as the stationary structure, includes dynamic pressure generating grooves G1, G2, and G4 formed in the outer surface thereof corresponding to the inner surface of the hub 225, and a dynamic pressure generating grove G3 formed in the outer surface thereof corresponding to the stop ring 226 formed integrally with the hub 225 and rotated together with the rotation of the hub 225.

The sleeve 230, which is provided with the hub receiving hole 233 formed through the central portion thereof so that hub 225 is disposed in the hub receiving hole 233, includes a large outer diameter portion 232, the outer surface of which corresponds to the inner surface of the hub 225, and a small outer diameter portion 234, the outer surface of which corresponds to the stop ring 226 to be fixed to the fixing cap 250.

In case that the axial boss unit 221, which is disposed in the hub receiving hole 233 of the sleeve 230, has the inclined cylindrical structure, the outer diameter of which is decreased from the upper end to the lower end, as shown in FIG. 6, at least one upper dynamic pressure generating groove G1 for generating upper thrust dynamic pressure is formed in a circumferential direction in the upper surface of the large outer diameter portion 232, at least one outer circumferential dynamic pressure generating groove G2 for generating outer circumferential radial dynamic pressure is formed in a circumferential direction in the outer circumferential surface of the large outer diameter portion 232, and at least one lower dynamic pressure generating groove G3 for generating lower thrust dynamic pressure is formed in a circumferential direction in the lower surface of the large outer diameter portion 232.

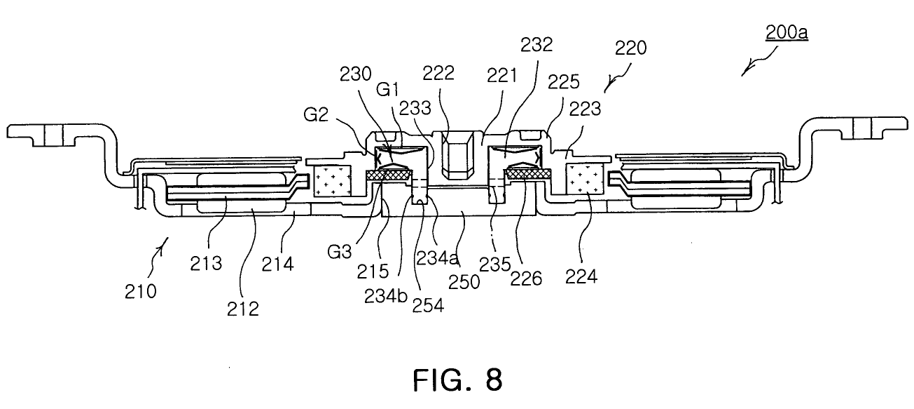

Further, in case that the axial boss unit 221 of a spindle motor 200a has the constant cylindrical structure, the outer diameter of which is constantly maintained from the upper end to the lower end as shown in FIG. 8, at least one upper dynamic pressure generating groove G1 for generating upper thrust dynamic pressure is formed in a circumferential direction in the upper surface of the large outer diameter portion 232, at least one lower dynamic pressure generating groove G3 for generating lower thrust dynamic pressure is formed in a circumferential direction in the lower surface of the large outer diameter portion 232, and at least one outer circumferential dynamic pressure generating groove G2 for generating outer circumferential radial dynamic pressure and at least one inner circumferential dynamic pressure generating groove G4 for generating inner circumferential radial dynamic pressure are selectively or simultaneously formed in a circumferential direction in the outer circumferential surface of the large outer diameter portion 232 and in the inner circumferential surfaces of the hub receiving hole 233 contacting the outer circumferential surface of the axial boss unit 221.

In this case, radial dynamic pressures generated from the inner and outer circumferential surfaces of the sleeve 230 are determined by the height of the sleeve 230 regardless of the height of the stop ring 226, and thrust dynamic pressures generated from the upper and lower surfaces of the sleeve 230 are maximally generated from the outer diameter of the sleeve 230. Thereby, it is possible to maximally expand the dimensions of portions for generating dynamic pressure.

The fixing cap 250 is a stationary member having a disk-shaped cross-section, which is fixedly inserted into the central hole 215 of the base 214 so as to hermetically seal the central hole 215, and the lower end of the sleeve 230 is fixed to the upper end of the fixing cap 250.

A disk-shaped fixing groove 254 having a designated depth, into which the lower end of the small outer diameter portion 234 of the sleeve 230 is inserted, is formed in the upper surface of the fixing cap 250. The lower end of the sleeve 230 may be integrally connected to the fixing groove 254 such that the lower end of the sleeve 230 is inserted into the fixing groove 254 and then bonded to the fixing groove 254 by a bonding agent, or the lower end of the sleeve 230 is inserted into the fixing groove 254 and then attached to the fixing groove 254 by thermocompression bonding.

In case that the lower end of the sleeve 230 is bonded to the fixing groove 254, preferably, at least one inner groove 234a and at least one outer groove 234b, which are filled with the bonding agent to increase the dimensions of the bonded portion, are formed in the inner and outer surfaces of the lower end of the sleeve 230.

Preferably, there is a gap having a designated distance between the lower surface of the axial boss unit 221 of the hub 225 and the upper surface of the fixing cap 250 so that the lower surface of the axial boss unit 221 does not contact the upper surface of the fixing cap 250, thereby not causing axial loss.

As shown in FIGS. 6 to 8, at least one vent hole 235, for connecting a space, formed between the hub receiving hole 233 of the sleeve 225 and the axial boss unit 221 of the hub 225, to the outside so that the space is kept at atmospheric pressure, is formed through the outer surface of the sleeve 230.

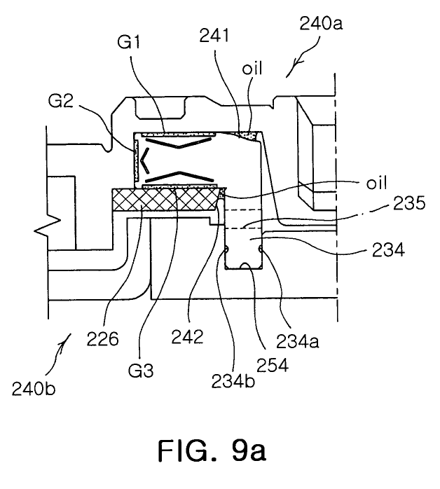

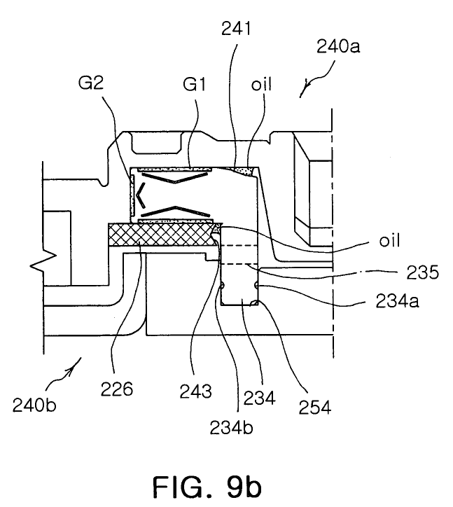

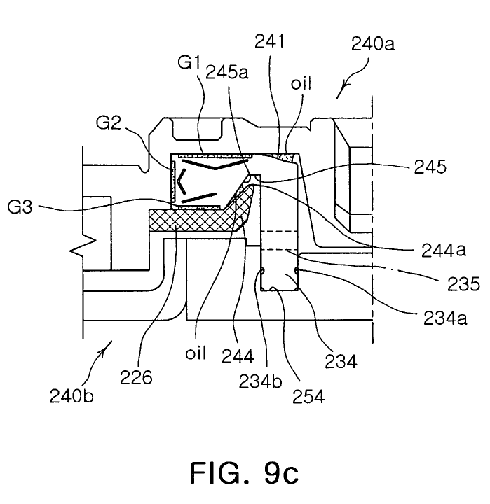

FIGS. 9a, 9b, and 9c illustrate upper and lower sealing and oil-storing units of the hydrodynamic pressure bearing spindle motor in accordance with the second embodiment of the present invention. The upper sealing and oil-storing unit 240a and the lower sealing and oil-storing unit 240b, which prevent lubricating oil, supplied to the dynamic pressure generating grooves G1, G2, and G3 formed in slide planes of the sleeve 230 for generating dynamic pressure due to the relative rotation of the rotary structure against the stationary structure, from flowing out, and store the lubricating oil, are selectively or simultaneously formed on the sleeve 230.

The upper sealing and oil-storing unit 240a is formed between the horizontal upper inner surface of the hub 225 and an inclined portion 241 sloping downwardly to the inner diameter to be gradually distant from the outer surface of the large outer diameter portion 232 of the sleeve 230 so that the upper sealing and oil-storing unit 240a prevents the lubricating oil, supplied to the upper dynamic pressure generating groove G1 of the sleeve 230, from flowing out, and stores the lubricating oil by means of the capillary action.

Further, the lower sealing and oil-storing unit 240b is formed between the vertical outer surface of the large outer diameter portion 232 of the sleeve 230 and a linear inclined portion 242 being gradually distant from the inner circumferential surface of the stop ring 226 from the upper end to the lower end so that the lower sealing and oil-storing unit 240b prevents the lubricating oil, supplied to the outer circumferential dynamic pressure generating groove G2 and the lower dynamic pressure generating groove G3, from flowing out, and stores the lubricating oil by means of the capillary action.

Here, the lower sealing and oil-storing unit 240b may be formed by the linear inclined portion 242 as shown in FIG. 9a, or may be formed by an inclined portion 243 having a V-shaped cross-section as shown in FIG. 9b so as to form a space for storing the lubricating oil between the inclined portion 243 and the vertical outer surface of the small outer diameter portion 234 of the sleeve 230. The inclined portion 243 may have an arc-shaped cross-section.

The lower sealing and oil-storing unit 240b includes a protrusion 244 slantingly protruded upwardly from the upper end of the inner circumferential surface of the stop ring 226, and a reception groove 245 formed in the outer surface of the sleeve 230 corresponding to the stop ring 226 for receiving the protrusion 244. An inclined plane 244a of the protrusion 244 has a gradient, against the horizontal bottom surface, lower than that of an inclined plane 245a of the reception groove 245 so that the inclined planes 244a and 245a facing each other do not contact. The inclined plane 244a of the protrusion 244 prevents the lubricating oil, supplied to the outer circumferential dynamic pressure generating groove G2 and the lower dynamic pressure generating groove G3 for generating outer circumferential radial dynamic pressure and lower thrust dynamic pressure, from flowing out, and stores the lubricating oil in the lower sealing and oil-storing unit 240b formed between the inclined planes 244a and 245a by means of the capillary action.

Here, preferably, the inclined plane 244a of the protrusion 244 has a gradient of 45 degrees or less against the horizontal bottom surface, and the inclined plane 245a of the reception groove 245 has a gradient of 45 degrees or more against the horizontal bottom surface.

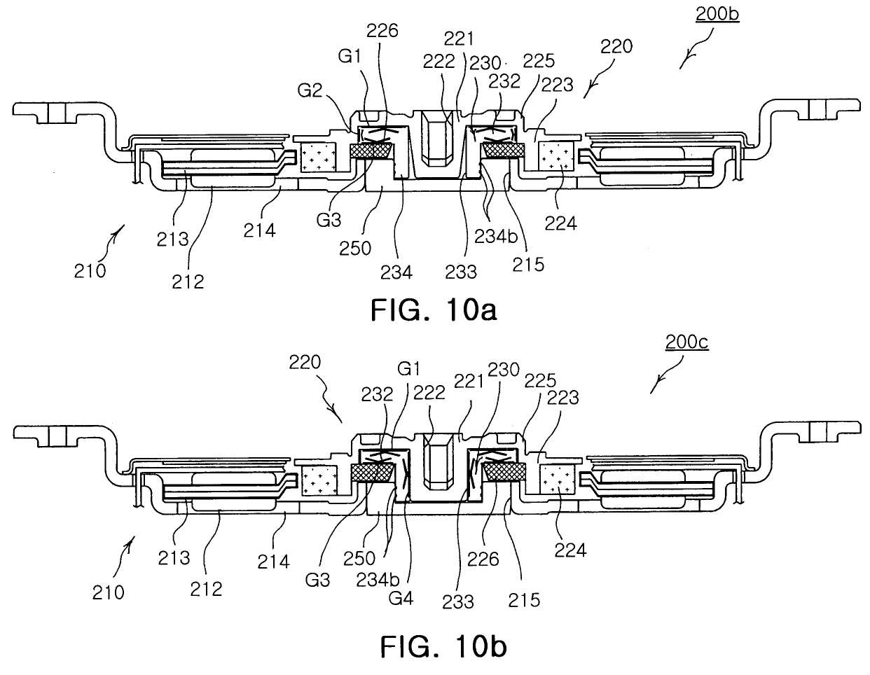

FIGS. 10a and 10b are schematic views of modifications of the hydrodynamic pressure bearing spindle motor in accordance with the second embodiment of the present invention. As shown in FIGS. 10a and 10b, each of hydrodynamic pressure bearing spindle motors 200b and 200c comprises the stator 210, the rotor 220, the sleeve 130, and the fixing cap 250. The hydrodynamic pressure bearing spindle motors 200b and 200c are divided according to the structures (the constant cylindrical structure and the inclined cylindrical structure) of the axial boss unit 211 assembled with the hub receiving hole 233 of the sleeve 230.

A circular-shaped fixing groove having a designated depth is formed in the upper surface of the fixing cap 250, which is fixedly inserted into the central hole 215 of the base 214 of the stator 210 for fixedly supporting the sleeve 230. The lower end of the sleeve 230, having passed through the hub receiving hole 233, is fixedly inserted into the fixing groove, the bottom of which is closed.

The lower end of the sleeve 230 may be integrally connected to the fixing groove of the fixing cap 250 such that the lower end of the sleeve 230 is inserted into the fixing groove and then bonded to the fixing groove by a bonding agent coated on the inner surface of the fixing groove and the outer surface of the sleeve 230, or the lower end of the sleeve 230 is inserted into the fixing groove and then attached to the fixing groove by thermocompression bonding.

At least one outer groove 234b having a disk shape is formed in the outer surface of the lower end of the sleeve 230 so as to increase the dimensions of the bonding portion using the bonding agent.

In the hydrodynamic pressure bearing spindle motors 100, 100a, 200, 200a, 200b, and 200c, the rotors 120 and 220 are rotatably assembled with the stators 110 and 210 by the sleeves 130 and 230. When power is applied to the winding coils 112 and 212 of the stators 110 and 210, an electric field having a designated intensity is formed on the winding coils 112 and 212, the hubs 125 and 225 of the rotors 120 and 220 starts rotating in one direction centering on the rotary shafts by the interaction between the electric fields, generated from the winding coils 112 and 212, and magnetic fields, generated from the magnets 124 and 224 of the rotors 120 and 220.

Since the herringbone-shaped or spiral-shaped dynamic pressure generating grooves G1, G2, G3, and G4 are formed in the outer surfaces of the sleeves 130 and 230, which contact the inner surfaces of the hubs 125 and 225 and correspond to the upper surfaces of the stop rings 126 and 226 rotated together with the rotations of the hubs 125 and 225, and the lubricating oil is supplied to the dynamic pressure generating grooves G1, G2, G3, and G4, when the rotors 120 and 220 are start rotating in one direction, the hubs 125 and 225 are rotated against the sleeves 130 and 230, serving as stationary members, and generate hydrodynamic pressure, thereby stably supporting the rotations of the rotors 120 and 220 against the stators 110 and 210.

Radial dynamic pressures of the inner and outer circumferential dynamic pressure generating grooves G2 and G4 formed in the sleeves 130 and 230 are generated throughout the overall outer circumferential surfaces of the large outer diameter portions 132 and 232 of the sleeves 130 and 230 and the overall inner circumferential surfaces of the hub receiving holes 133 and 233 of the sleeves 130 and 230, and thrust dynamic pressures of the upper and lower surfaces of the large outer diameter portions 132 and 232 of the sleeves 130 and 230 are expanded to the outer parts of the large outer diameter portions 132 and 232, thereby increasing the dimensions of portions for generating hydrodynamic pressure, thus improving axial rigidity of the sleeves 130 and 230 for stably supporting the high-speed rotation of the rotors 120 and 220 against the stators 110 and 210.

In case that the axial rigidity of the sleeves 130 and 230 is improved, low-viscosity lubricating oil is used as a substitute for the high-viscosity lubricating oil, thereby reducing axial loss.

The lubricating oil, supplied to generate upper thrust dynamic pressure between the upper surfaces of the large outer diameter portions 132 and 232 of the sleeves 130 and 230 and the inner surfaces of the hubs 125 and 225, is partially leaked from the slide planes to the hub receiving holes 133 and 233, and the leaked oil does not flow toward the lower part of the hub receiving holes 133 and 233, but rather is stored by the upper sealing and oil-storing units 140a and 240a, formed between the inclined portions 141 and 241 of the sleeves 130 and 230 and the inner surfaces of the hubs 125 and 225, by means of the capillary action. Thereby, the oil is not leaked from the slide planes by the part of the oil stored by the upper sealing and oil-storing units 140a and 240a.

Here, the upper sealing and oil-storing units 140a and 240a communicate with the outside by the vent holes 135 and 235 formed through the outer surfaces of the sleeves 130 and 230, thereby being maintained at atmospheric pressure.

The lower sealing and oil-storing units 140b and 240b, for storing the oil leaked from the outer circumferential radial dynamic pressure generating portions and the lower thrust dynamic pressure generating portions of the sleeves 130 and 230, are formed between the inner surfaces of the stop rings 126 and 226 and the outer surfaces of the sleeves 130 and 230 corresponding to the inner surfaces of the stop rings 126 and 226, thereby being sealed to prevent the leakage of the oil.

As apparent from the above description, the present invention provides a hydrodynamic pressure bearing spindle motor, in which radial dynamic pressure generating portions having maximal dimensions are formed in overall inner and outer circumferential surfaces of a sleeve regardless of the height of a stop ring, and thrust dynamic pressure generating portions having maximal dimensions are formed in upper and lower surfaces of the sleeve and extended to an outer diameter portion of the sleeve, thereby improving the axial rigidity of the sleeve for stably supporting the high-speed rotation of the rotor, thus reducing axial loss by means of the use of low-viscosity oil, improving the stability in rotation of the motor, and reducing power consumption.

Further, the hydrodynamic pressure bearing spindle motor of the present invention prevents negative effects of thermally-expanded oil existing on dynamic pressure non-generating portions, thereby increasing the load capacity of the motor.

Moreover, the hydrodynamic pressure bearing spindle motor of the present invention reduces the number of required components, decreases the necessary degree of precision in processing a shaft to reduce the production costs, and simplifies an assembly process to improve the efficiency of assembly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A hydrodynamic pressure bearing spindle motor comprising:
a stator including a core, on which at least one winding coil is wound, and a base provided with a central hole formed through the central area of the main body thereof so that the core is placed on the upper surface thereof;
a rotor including a hub having a magnet formed on the outer circumference thereof to correspond to the winding coil leaving a designated interval with the winding coil, and a stop ring integrally installed on the inner circumference of the hub; and
a sleeve, for supporting the rotation of the rotor against the stator, including at least one dynamic pressure generating groove formed on the outer surface thereof correspondingly contacting the inner circumference of the hub and the stop ring, and a hub receiving hole formed through the central area of the main body thereof assembled with the central hole of the base.

2. The hydrodynamic pressure bearing spindle motor as set forth in claim 1, wherein the hub includes:
an axial boss unit protruded downwardly from the main body of the hub and inserted into the hub receiving hole; and
a skirt unit having a hollow cylindrical structure provided with the outer circumference, on which the magnet is placed, and the inner circumference, on which the stop ring is placed.

3. The hydrodynamic pressure bearing spindle motor as set forth in claim 2,
wherein the axial boss unit has a constant cylindrical structure having a constant outer diameter so that the outer surface of the axial boss unit contacts the inner surface of the hub receiving hole.

4. The hydrodynamic pressure bearing spindle motor as set forth in claim 2,
wherein the axial boss unit has an inclined cylindrical structure having an outer diameter gradually decreased from the upper end to the lower end so that the outer surface of the axial boss unit is separated from the inner surface of the hub receiving hole.

5. The hydrodynamic pressure bearing spindle motor as set forth in claim 2,
wherein there is a gap having a designated size between the lower surface of the axial boss unit and the bottom surface of the hub receiving hole.

6. The hydrodynamic pressure bearing spindle motor as set forth in claim 1, wherein:
the sleeve includes a large outer diameter portion, through which the hub receiving hole is formed, and a small outer diameter portion, which is assembled with the central hole of the base;
at least one upper dynamic pressure generating groove for generating upper thrust dynamic pressure is formed in the upper surface of the large outer diameter portion corresponding to the upper inner surface of the hub;
at least one outer circumferential dynamic pressure generating groove for generating outer circumferential radial dynamic pressure is formed in the outer circumferential surface of the large outer diameter portion corresponding to the inner circumferential surface of the hub; and
at least one lower dynamic pressure generating groove for generating lower thrust dynamic pressure is formed in the lower surface of the large outer diameter portion corresponding to the upper surface of the stop ring.

7. The hydrodynamic pressure bearing spindle motor as set forth in claim 1, wherein:
the sleeve includes a large outer diameter portion, through which the hub receiving hole is formed, and a small outer diameter portion, which is assembled with the central hole of the base;
at least one upper dynamic pressure generating groove for generating upper thrust dynamic pressure is formed in the upper surface of the large outer diameter portion corresponding to the upper inner surface of the hub;
at least one inner circumferential dynamic pressure generating groove for generating inner circumferential radial dynamic pressure is formed in the inner circumferential surface of the hub receiving hole; and
at least one lower dynamic pressure generating groove for generating lower thrust dynamic pressure is formed in the lower surface of the large outer diameter portion corresponding to the upper surface of the stop ring.

8. The hydrodynamic pressure bearing spindle motor as set forth in claim 1, wherein:
the sleeve includes a large outer diameter portion, through which the hub receiving hole is formed, and a small outer diameter portion, which is assembled with the central hole of the base;
at least one upper dynamic pressure generating groove for generating upper thrust dynamic pressure is formed in the upper surface of the large outer diameter portion corresponding to the upper inner surface of the hub;
at least one outer circumferential dynamic pressure generating groove for generating outer circumferential radial dynamic pressure is formed in the outer circumferential surface of the large outer diameter portion corresponding to the inner circumferential surface of the hub;
at least one inner circumferential dynamic pressure generating groove for generating inner circumferential radial dynamic pressure is formed in the inner circumferential surface of the hub receiving hole; and
at least one lower dynamic pressure generating groove for generating lower thrust dynamic pressure is formed in the lower surface of the large outer diameter portion corresponding to the upper surface of the stop ring.

9. The hydrodynamic pressure bearing spindle motor as set forth in claim 1,
wherein at least one vent hole is formed through the outer surface of the sleeve so that the vent hole communicates with the hub receiving hole.

10. The hydrodynamic pressure bearing spindle motor as set forth in claim 1,
wherein the sleeve further includes selectively or simultaneously an upper sealing and oil-storing unit and a lower sealing and oil-storing unit, which prevent lubricating oil, supplied to the dynamic pressure generating grooves, from flowing out, and store the lubricating oil.

11. The hydrodynamic pressure bearing spindle motor as set forth in claim 10,
wherein the upper sealing and oil-storing unit is formed between the horizontal upper inner surface of the hub and an inclined portion sloping downwardly to the inner diameter to be gradually distant from the upper surface of the sleeve.

12. The hydrodynamic pressure bearing spindle motor as set forth in claim 10,
wherein the lower sealing and oil-storing unit is formed between the vertical outer surface of the sleeve and an inclined portion being gradually distant from the inner circumferential surface of the stop ring from the upper end to the lower end.

13. The hydrodynamic pressure bearing spindle motor as set forth in claim 12,
wherein the inclined portion has a V-shaped or arc-shaped cross-section.

14. The hydrodynamic pressure bearing spindle motor as set forth in claim 10,
wherein the lower sealing and oil-storing unit is formed between a protrusion slantingly protruded upwardly from the upper end of the inner circumferential surface of the stop ring, and a reception groove formed in the outer surface of the sleeve corresponding to the stop ring for receiving the protrusion.

15. The hydrodynamic pressure bearing spindle motor as set forth in claim 14,
wherein an inclined plane of the protrusion has a gradient, against the horizontal bottom surface, lower than that of an inclined plane of the reception groove so that the inclined planes facing each other do not contact.

16. A hydrodynamic pressure bearing spindle motor comprising:
a stator including a core, on which at least one winding coil is wound, and a base provided with a central hole formed through the central area of the main body thereof so that the core is placed on the upper surface thereof;
a rotor including a hub having a magnet formed on the outer circumference thereof to correspond to the winding coil leaving a designated interval with the winding coil, and a stop ring integrally installed on the inner circumference of the hub;
a sleeve, for supporting the rotation of the rotor against the stator, including at least one dynamic pressure generating groove formed on the outer surface thereof correspondingly contacting the inner circumference of the hub and the stop ring, and a hub receiving hole formed through the central area of the main body thereof for receiving the hub; and
a fixing cap assembled with the central hole of the base for fixedly supporting a lower end of the sleeve.

17. The hydrodynamic pressure bearing spindle motor as set forth in claim 16,
wherein a disk-shaped fixing groove, into which inner and outer surfaces of the lower end of the sleeve provided with the hub receiving hole are fixedly inserted, is formed in the upper surface of the fixing cap.

18. The hydrodynamic pressure bearing spindle motor as set forth in claim 17,
wherein the inner and outer surfaces of the lower end of the sleeve are connected to the fixing groove by a bonding agent.

19. The hydrodynamic pressure bearing spindle motor as set forth in claim 17,
wherein at least one disk-shaped inner groove and at least one disk-shaped outer groove are respectively formed in the inner and outer surfaces of the lower end of the sleeve.

20. The hydrodynamic pressure bearing spindle motor as set forth in claim 17,
wherein the lower end of the sleeve is connected to the fixing groove by thermocompression bonding.

21. The hydrodynamic pressure bearing spindle motor as set forth in claim 16,
wherein a circular-shaped fixing groove, into which an outer surface of the lower end of the sleeve provided with the hub receiving hole is fixedly inserted, is formed in the upper surface of the fixing cap.

22. The hydrodynamic pressure bearing spindle motor as set forth in claim 16,
wherein the inner and outer surfaces of the lower end of the sleeve are connected to the fixing groove by a bonding agent.

23. The hydrodynamic pressure bearing spindle motor as set forth in claim 22,
wherein at least one disk-shaped outer groove is formed in the outer surface of the lower end of the sleeve.
